(19) United States
(12) Patent Application Publication
(10) Pub. No.: US 2025/0066249 A1
(43) Pub. Date: Feb. 27, 2025

(54) E-STONE BASED ARTIFICIAL MARBLE AND MANUFACTURING METHOD THEREFOR

(71) Applicant: LX HAUSYS, LTD., Seoul (KR)

(72) Inventors: Seong-Hoon YUE, Seoul (KR); Youngwoo CHOI, Seoul (KR); Joongheon LEE, Seoul (KR); Donghee KIM, Seoul (KR); Yechan KIM, Seoul (KR); Joo-Hwan SEO, Seoul (KR); Eunhee KANG, Seoul (KR); Hongkwan CHO, Seoul (KR); Sangnam LEE, Seoul (KR)

(73) Assignee: LX HAUSYS, LTD., Seoul (KR)

(21) Appl. No.: 18/726,732

(22) PCT Filed: Jan. 26, 2023
(86) PCT No.: PCT/KR2023/001192

§ 371 Date: Jul. 3, 2024

(30) Foreign Application Priority Data
Jan. 26, 2022 (KR) 10-2022-0011437
Dec. 23, 2022 (KR) 10-2022-0183380
Dec. 23, 2022 (KR) 10-2022-0183389
Dec. 23, 2022 (KR) 10-2022-0183400

(51) Int. Cl. C04B 26/18; B29C 43/20; B29C 43/32; B29K 67/00; B29K 105/00; B29K 509/00; C04B 14/06; C04B 40/00

(52) U.S. Cl. CPC C04B 26/18; B29C 43/20; C04B 14/06; C04B 40/0067; C04B 40/0071; C04B 40/0082; B29C 2043/3266; B29K 2067/00; B29K 2105/0058; B29K 2105/251; B29K 2509/14

(57) ABSTRACT

An E-stone based artificial marble according to an exemplary embodiment of the present invention is formed of inorganic particles, inorganic powder, and a resin, wherein the resin is an E-stone based composition including a liquid resin and a solid powder resin or a cured product thereof.

### TECHNICAL FIELD

This application claims priority to and the benefit of Korean Patent Application No. 10-2022-0011437 filed in the Korean Intellectual Property Office on Jan. 26, 2022, Korean Patent Application No. 10-2022-0183400 filed in the Korean Intellectual Property Office on Dec. 23, 2022, Korean Patent Application No. 10-2022-0183389 filed in the Korean Intellectual Property Office on Dec. 23, 2022, and Korean Patent Application No. 10-2022-0183380 filed in the Korean Intellectual Property Office on Dec. 23, 2022, the entire contents of which are incorporated herein by reference.

The present invention relates to an E-stone based artificial marble and a method for manufacturing the same.

### BACKGROUND ART

Representative types of an artificial marble include polyester-based artificial marble, epoxy-based artificial marble, melamine-based artificial marble, and engineered stone-based artificial marble. The artificial marble has a beautiful appearance and excellent workability, is lighter than natural marble, and has excellent strength, and thus, the artificial marble is widely used as a counter table and various interior materials. The artificial marble, as it is known to date, implements an appearance effect mainly through a combination of monochrome opaque chips. However, this approach has limitations in implementing patterns similar to those of natural marble, granite, or the like, in the artificial marble. Accordingly, much research is underway in order to develop artificial marble with an appearance close to that of natural marble.

Engineered stone is artificial marble, also called E-stone, and is an interior design material that has a texture and feel similar to those of natural stone. In the industries, researches have been made to enhance an aesthetic sense by improving color-development, shape and the like of artificial marble. For example, Korean Patent No. 10-1270415 discloses an artificial marble with various patterns and appearances using marble chips. Demand for engineered stone is gradually increasing for interior floors, wall decorations, and kitchen worktops, and most of the products imitate natural stone species such as granite and marble.

In the manufacturing process, the engineered stone is usually manufactured by vacuum-vibration pressing a composition lumped using quartz with large particles, quartz powder with small particles, and a binder resin. At this time, in order to physically mix the compositions well, the binder resin is first mixed with quartz with large particles to coat a surface of the quartz with the binder resin, and then powder is added to prepare a mixture. Such a mixture of quartz-binder resin-particle units is a dry phase that is easy to process but has a characteristic of being able to maintain its shape by resisting a certain level of external force, along with a rustling feeling like wet sand.

Recently, as user needs for design increase, there are attempts to decorate a surface of the engineered stone to form patterns similar to those of natural stone species. However, as described above, the mixture for engineered stone does not exhibit liquid-like flowability when producing patterns due to its form of resistance to external forces, and the patterns needs to be formed using, for example, rustling sand.

In particular, when a pattern is formed through a small-sized discharge port in order to form a thin-width pattern, a discharge port on a lower surface is frequently clogged and needs to be cleaned, making it unsuitable for mass production. When the size of the discharge port is expanded in order to facilitate the discharge of the mixture for a pattern, not only it is difficult to form a pattern having a thin thickness, a thin width or the like, but an amount of the discharge is not constant due to repeated uncontrolled discharge of excessive and small amounts, leading to a final product with an inconsistent pattern. Therefore, it is difficult to manufacture an appropriately thin and stable pattern using the composition and discharge method of the related art.

### DETAILED DESCRIPTION OF THE INVENTION

### Technical Problem

The present invention provides an E-stone based artificial marble and a method for manufacturing the same. More specifically, the present invention provides an E-stone based artificial marble and a method for manufacturing the same, which can implement a thin and stable pattern.

### Technical Solution

An exemplary embodiment of the present invention provides an E-stone based artificial marble formed of an inorganic particle, inorganic powder, and a resin, wherein the resin is an E-stone based composition including a liquid resin and a solid powder resin or a cured product thereof.

In addition, another exemplary embodiment of the present invention provides a method for manufacturing an E-stone based artificial marble, the method including:
forming a base layer into a plate shape by distributing a resin composition for a base into a horizontally oriented mold;
forming an engraved pattern in the base layer; discharging a resin composition for a pattern into the engraved pattern; and
performing a vibration and compression process and then performing a thermal curing process to form an artificial marble including a base region and a pattern region,
wherein a width of the pattern is less than 2 cm and a length is 5 cm or longer, and
wherein the resin composition for a base and the resin composition for a pattern are different from each other in components.

In addition, still another exemplary embodiment of the present invention provides a method for manufacturing an E-stone based artificial marble, the method including:
manufacturing an artificial marble composition including a liquid resin, an inorganic particle with a particle size of greater than 1.18 mm, an inorganic particle with a particle size of 0.1 mm or greater and 1.18 mm or less, inorganic powder with a particle size of less than 0.1 mm, and a solid powder resin; and
putting the artificial marble composition into a mold, performing a vibration and compression process, and then performing a thermal curing process to form an artificial marble.

### Advantageous Effects

The E-stone based artificial marble according to an exemplary embodiment of the present invention can stably implement a pattern with a width of less than 2 cm and a length of 5 cm or longer.

In addition, the method for manufacturing an E-stone based artificial marble according to an exemplary embodiment of the present invention can form a natural flow pattern in the artificial marble by forming an engraved pattern on the base layer and discharging a resin composition into the engraved pattern.

In addition, according to an exemplary embodiment of the present invention, the resin composition for a pattern includes both a liquid resin and a solid powder resin and satisfies the characteristic of an Avalanche Energy value of 18 mJ/Kg or less, so that flowability of the resin composition for a pattern can be improved, problems such as clogging of discharge equipment and discharge defects that may occur when discharging the resin composition for a pattern can be solved, and occurrence of pinholes when forming a pattern of artificial marble can be suppressed.

### BRIEF DESCRIPTION OF DRAWINGS

FIG. 1 shows an artificial marble according to an exemplary embodiment of the present invention.

FIG. 2 schematically shows a thermal curing process in a method for manufacturing an artificial marble according to an exemplary embodiment of the present invention.

FIG. 3 shows an artificial marble according to Example 10 of the present invention.

FIG. 4 shows an artificial marble according to Comparative Example 9 of the present invention.

FIG. 5 shows an artificial marble according to Comparative Example 10 of the present invention.

FIG. 6 shows an artificial marble according to Comparative example 11 of the present invention.

### EXPLANATION OF REFERENCE NUMERALS AND SYMBOLS

10: liquid resin
20: inorganic particle
30: inorganic powder
40: solid powder resin
50: liquid resin converted as a result of solid powder resin being melted

### BEST MODE

Hereinafter, the present invention will be described in more detail.

Throughout the present invention, when a member is referred to as being “on” another member, the member may be in direct contact with another member or an intervening member may also be present between two members.

In the present invention, when a part is referred to as “including” a certain component, it means that the part can further include another component, not excluding another component, unless explicitly described to the contrary.

In the related art, when forming a pattern of artificial marble, a composition including inorganic particles such as silica particles and quartz particles and an inorganic pigment is used. However, such a composition lacks a resin that can hold inorganic substances such as inorganic particles and inorganic pigments, so there is a problem of pinholes occurring in a pattern of artificial marble. In order to improve this, a liquid binder resin including an unsaturated polyester resin is applied to the composition for pattern formation, but boiling or bubbles are generated in a region where the liquid binder resin is gathered, and as a result, pinholes are still formed in a pattern of artificial marble.

In addition, in the related art, only the liquid binder resin is applied as a binder resin to the artificial marble composition, so the flowability of the artificial marble composition is low, and as a result, there is a problem in that the discharge equipment is clogged or a discharge defect occurs during the discharge process of the artificial marble composition.

The above discharge defect is described in detail. Artificial marble, such as E-stone, is manufactured from a binder, inorganic particles, and inorganic powder. In this case, the powder and binder should fill voids between particles to prevent pinholes and achieve uniform physical properties. Therefore, the binder (wet phase) is sufficiently mixed with the inorganic particles (dry phase) to coat the inorganic particles with the binder (wet phase after mixing), and the inorganic powder is mixed with the coated binder to form a solid phase mixture (dry phase after mixing). Then, the mixture is sprayed (in the present specification, this is expressed as ‘distributed’) on a required location, which is then is vacuum-vibrated (pressed) and thus thermally cured.

In this process, when it is intended to form an additional pattern in the artificial marble, a process of forming an engraved portion of a desired pattern and then discharging a composition for pattern formation into the engraved portion is adopted.

In this case, when an inlet of a discharge port used in the discharge process is small, even if the composition for pattern formation is in a dry phase, the composition does not have perfect flowability at the narrow inlet because it has been mixed with the viscous binder. Therefore, it is difficult to always discharge an appropriate amount, making it difficult to create a pattern of a certain thickness or less or to create a uniform pattern. Further, as described above, the discharge equipment is clogged or a discharge defect occurs.

Accordingly, the present invention has been made in an effort to provide an E-stone based artificial marble and a method for manufacturing the same, which can realize a natural flow pattern by using a resin composition for a pattern with excellent flowability and discharge characteristics. In addition, the present invention has been made in an effort to provide an E-stone based artificial marble with a thin flowing pattern or a pattern with a constant thickness or width, which were not seen in the E-stone based artificial marbles of the related art, by using a resin composition for a pattern with excellent flowability and discharge characteristics.

An E-stone based artificial marble according to an exemplary embodiment of the present invention is formed of inorganic particles, inorganic powder, and a resin, wherein the resin is an E-stone based composition including a liquid resin and a solid powder resin or a cured product thereof.

In an exemplary embodiment of the present invention, a content of the liquid resin is 7 wt % to 12 wt % and a content of the solid powder resin is 8 wt % to 14 wt %, based on a total weight of the E-stone based composition, and an Avalanche Energy value of the E-stone based composition is 18 mJ/Kg or less.

The E-stone based artificial marble according to an exemplary embodiment of the present invention includes a base region and a pattern region, a width of the pattern is less than 2 cm and a length is 5 cm or longer, and a resin composition for a base and a resin composition for a pattern forming the base region and the pattern region are different from each other in components.

In an exemplary embodiment of the present invention, the resin composition for a pattern may include a first resin or a cured product thereof, and a second resin or a cured product thereof. That is, the resin composition for a pattern may include two types of resins or cured products thereof, and at room temperature, the first resin may be a liquid resin and the second resin may be a solid resin. More specifically, the first resin may be an unsaturated polyester resin, and the second resin may include one or more selected from an epoxy acrylate resin, a saturated polyester resin, a glycidyl methacrylate resin, a butyl methacrylate resin, and a methyl methacrylate resin.

In an exemplary embodiment of the present invention, a deviation of the width of the pattern defined by Mathematical Formula 1 below may be 5% or less, or 3% or less. Since the deviation of the width of the pattern is 5% or less, a pattern with a constant width can be formed.

$$Deviation of width of pattern ( \% ) = [ ( λ - B ) / C ] \times 100 ( \% ) \qquad [ Mathematical Formula 1 ]$$

in Mathematical Formula 1,
A represents a maximum width of the pattern,
B represents a minimum width of the pattern, and
C represents an average width of the pattern.

In addition, a method for manufacturing an E-stone based artificial marble according to an exemplary embodiment of the present invention includes forming a base layer into a plate shape by distributing a resin composition for a base into a horizontally oriented mold; forming an engraved pattern in the base layer; discharging a resin composition for a pattern into the engraved pattern; and performing a vibration and compression process and then performing a thermal curing process to form an artificial marble including a base region and a pattern region, wherein a width of the pattern is less than 2 cm and a length is 5 cm or longer, and wherein the resin composition for a base and the resin composition for a pattern are different from each other in components.

The method for manufacturing an E-stone based artificial marble according to an exemplary embodiment of the present invention includes a step of forming a base layer into a plate shape by distributing a composition for a base into a horizontally oriented mold.

The mold may be a container with a certain shape so that the composition for a base discharged from a hopper can be contained in a certain shape. In particular, in an exemplary embodiment of the present invention, a base layer is formed into a plate shape in a state in which the mold is oriented horizontally. This may be different from a process of the related art in which different types of mixtures of natural quartz, unsaturated polyester liquid resin, and solid pigment are prepared and vertically stacked.

The base layer may be formed by injecting the composition for a base into a plurality of hoppers controlled by a digital distributor and then distributing the same in the mold.

The composition for a base may include a liquid resin, inorganic particles, and quartz powder. The descriptions of the liquid resin, inorganic particles, and quartz powder of the composition for a base are the same as the descriptions of the liquid resin, inorganic particles, and quartz powder described in the resin composition for a pattern described later.

The method for manufacturing an E-stone based artificial marble according to an exemplary embodiment of the present invention includes a step of forming an engraved pattern in the base layer.

When forming a pattern in an artificial marble, in order to form a relatively wide pattern, it is general to separately mix compositions made to have different colors using pigments or the like, prepare a location where a pattern is to be formed, and then distribute the mixture to the location. In addition, for a pattern at a level of thin decorative lines, it is general to spray liquid pigment directly on the distributed base, or to form a shallow path by lightly stamping the base with a pre-prepared embossing frame and then to spray liquid pigment on the base.

The process of forming an engraved pattern of the present invention refers to a step of preparing a location where a pattern is to be formed, in the case of the former having a separate composition among the above-described pattern forming process for imparting a pattern to an artificial marble. The process of forming an engraved pattern in which a location where a pattern is to be formed is secured includes the following method, but is not limited thereto.

### 1) Use of a Tool

With a tool having a shovel or chisel-like shape, an engraved pattern can be secured while putting aside the base to a side along a path of a pattern to be formed, or removing the base with a means such as a suction device. This method can impart a natural feel when it is used to implement a stone or design in which boundaries are unclear because the composition for a base on the side often collapses and gets mixed in in many cases even after securing the engraved pattern.

### 2) Embossing Frame (Emboss Plate)

Rather than putting away or removing the composition in the pattern region to the side, the composition is pressed to secure a space. A pre-designed embossing frame (emboss plate) may be placed on the distributed base, and pressure may be applied to form an engraved pattern.

The embossing frame (emboss plate) may be used alone, but may also be used along with various auxiliary means. For example, when an auxiliary mask with a partition is additionally used, an embossing frame of the same shape as an auxiliary mask perforation position may be applied. In this case, even after the embossing frame is removed, the composition on a side does not get mixed into the pattern region by the partition of the auxiliary mask, making it possible to form a neat pattern.

### 3) Use of a Specific Tool for Securing an Engraved Pattern of a Specific Shape

When a shape in a depth direction of an artificial marble as well as a shape of an artificial marble surface is important, a precisely designed tool may be used to secure an engraved pattern with a controlled shape in the depth direction. For example, an asymmetrical engraved pattern may be formed by pressing the base with a tool designed to be vertical on one side and diagonal on the other side. When an asymmetric pattern is filled with a highly transparent pattern (such as glass or a highly transparent composition), a gradation effect may be exhibited in the depth direction.

### 4) Pattern Frame

Before distributing the base, a pattern frame formed with a pattern region is installed in advance and then the base is distributed. After removing the pattern frame, the same engraved pattern as the pattern frame can be secured.

In addition, the method for manufacturing an E-stone based artificial marble according to an exemplary embodiment of the present application includes a step of discharging a resin composition for a pattern into the engraved pattern.

The step of discharging the resin composition for a pattern is a step of filling the formed engraved pattern by discharging the resin composition for a pattern after the step of forming the engraved pattern. In the step of discharging the resin composition for a pattern, a machine or equipment capable of discharging the resin composition for a pattern may be used.

In the step of discharging the resin composition for a pattern, a size of a discharge port may be appropriately adjusted. When a width of the engraved pattern is large, a large-sized discharge port may be used, and when the width of the engraved pattern is small, a small-sized discharge port may be used.

In the case where the size of the discharge port is small, if the flowability of the resin composition for a pattern is not good, the discharge port may be periodically clogged, or there may be severe deviations, such as the resin composition coming out all at once or only a little bit. Therefore, the smaller the size of the discharge port, the better the flowability of the resin composition for a pattern should be. For example, in order to stably and constantly form a pattern of a width less than 2 cm, a composition having an Avalanche Energy value of 18 mJ/Kg or less may be used.

In order to form a composition having an Avalanche Energy value of 18 mJ/Kg or less, an amount of liquid resin included in the composition may be reduced. However, if the Avalanche energy is reduced by reducing the amount of liquid resin, surface defects such as pinholes may be generated due to an insufficient amount of binder resin. In this case, therefore, a solid binder resin may be used together.

The discharge port and the discharge equipment may have various forms. For example, an actuator or a vibration device may be provided to discharge the composition little by little by slight shaking.

With the process described above, a pattern such as a vein pattern of the artificial marble can be implemented in the form of various colors, and thin and clear patterns with one or two or more colors can be formed adjacent to each other, and forms such as a natural flow pattern, such as a gradation color, and a blur pattern can also be implemented. Accordingly, the pattern according to an exemplary embodiment of the present invention may have two or more colors, a gradation color, or a combination color thereof. Additionally, the pattern according to an exemplary embodiment of the present invention may include a line pattern, a curved pattern, or a combination pattern thereof.

The resin composition for a pattern may include a liquid resin including an unsaturated polyester resin; a solid powder resin; inorganic particles; and inorganic powder.

A resin composition for a pattern according to an exemplary embodiment of the present invention includes a liquid resin including an unsaturated polyester resin; a solid powder resin; inorganic particles; and inorganic powder, wherein a content of the liquid resin is 7 wt % to 12 wt % and a content of the solid powder resin is 8 wt % to 14 wt %, based on a total weight of the resin composition for a pattern, and wherein an Avalanche Energy value of the resin composition for a pattern is 18 mJ/Kg or less.

Below, each component of the resin composition for a pattern and the E-stone based composition will be described.

### Liquid Resin

In an exemplary embodiment of the present invention, the composition includes a liquid resin including an unsaturated polyester resin.

In an exemplary embodiment of the present invention, the liquid resin may be manufactured by mixing and dispersing 0.4 to 2.5 parts by weight of a curing agent, 0.05 to 0.3 part by weight of a catalyst, and 0.5 to 7 parts by weight of a coupling agent on the basis of 100 parts by weight of the unsaturated polyester resin.

In an exemplary embodiment of the present invention, the liquid resin may include 90 wt % or more of an unsaturated polyester resin, and the unsaturated polyester resin may be manufactured using a composition including an unsaturated polyester polymer and a vinylic monomer at a weight ratio of 100:30 to 70. More preferably, the unsaturated polyester resin may be manufactured using a composition including 60 wt % to 75 wt % of the unsaturated polyester polymer and 25 wt % to 40 wt % of the vinylic monomer.

A weight average molecular weight of the unsaturated polyester resin may be 1,000 g/mol to 10,000 g/mol.

The unsaturated polyester polymer is not particularly limited, and examples thereof may include an unsaturated polyester polymer manufactured through a condensation reaction of a saturated or unsaturated dibasic acid and a polyhydric alcohol. Examples of the saturated or unsaturated dibasic acid may include ortho-phthalic acid, isophthalic acid, maleic anhydride, citraconic acid, fumaric acid, itaconic acid, phthalic acid, phthalic anhydride, terephthalic acid, succinic acid, adipic acid, sebacic acid or tetrahydrophthalic acid. In addition, examples of the polyhydric alcohol may include ethylene glycol, diethylene glycol, triethylene glycol, propylene glycol, dipropylene glycol, tripropylene glycol, polypropylene glycol, 1,3-butylene glycol, hydrogenated bisphenol A, trimethylolpropane monoaryl ether, neopentyl glycol, 2,2,4-trimethyl-1,3-pentadiol and/or glycerin. In addition, if necessary, a monobasic acid such as acrylic acid, propionic acid or benzoic acid, or a polybasic acid such as trimellitic acid or tetracarboxylic acid of benzol may be further used.

Examples of the type of vinylic monomer may include an alkyl acrylate monomer or an aromatic vinylic monomer. However, it is preferable to use an aromatic vinylic monomer in consideration of reactivity with the unsaturated polyester polymer. For example, as the aromatic vinylic monomer, one or more selected from styrene, α-methylstyrene, p-methylstyrene, vinyl toluene, alkyl styrene substituted with an alkyl group having 1 to 3 carbon atoms, and styrene substituted with a halogen may be used, and preferably, a styrene monomer may be used.

The curing agent may be included for a curing reaction of the binder, and is not particularly limited as long as a curing agent that is used when manufacturing artificial marble, particularly engineered stone is used. The curing agent may be an organic peroxide-based compound or an azo-based compound. The organic peroxide-based compound may be one or two or more selected from a tert-butyl peroxybenzoate thermal curing agent (TBPB, Trigonox C, akzo nobel), diacyl peroxide, hydroperoxide, ketone peroxide, peroxy ester, peroxy ketal, dialkyl peroxide, alkyl perester, percarbonate, and peroxydicarbonate. For example, the curing agent may be tert-butyl peroxybenzoate thermal curing agent, benzoyl peroxide, dicumyl peroxide, butyl hydroperoxide, cumyl hydroperoxide, methyl ethyl ketone peroxide, t-butyl peroxy maleic acid, t-butyl hydroperoxide, acetyl peroxide, lauroyl peroxide, t-butyl peroxy neodecanoate, or tamyl peroxy 2-ethyl hexanoate, but is not necessarily limited thereto.

In addition, the azo-based compound may be azobisisobutyronitrile, but is not necessarily limited thereto.

The liquid resin may include 0.4 to 2.5 parts by weight of the curing agent on the basis of 100 parts by weight of the unsaturated polyester resin. When the curing agent is included in an amount of 0.4 part by weight or more, the binder can be sufficiently cured, and when the curing agent is included in an amount of 2.5 parts by weight or less, discoloration of the binder due to a high exothermic reaction and bubbles due to boiling can be prevented.

The catalyst may be included for promoting curing of the binder at low temperature, and is not particularly limited as long as a catalyst that is used when manufacturing artificial marble, particularly engineered stone is used. The catalyst may be one or two or more selected from cobalt-based, vanadium-based, or manganese-based metal soaps; tertiary amines; quaternary ammonium salts; and mercaptans. For example, a cobalt 6% catalyst (Hex-Cem, Borchers) may be used. The binder resin may include 0.05 to 0.3 part by weight of the catalyst on the basis of 100 parts by weight of the unsaturated polyester resin. It is advantageous to promote curing when the catalyst is included in an amount of 0.05 parts by weight or more, and discoloration of the binder can be prevented when the catalyst is included in an amount of 0.3 parts by weight or less.

The coupling agent may be included to improve bonding force between the binder resin and inorganic particles and/or quartz powder, and may be a silane-based or silicate-based coupling agent. The binder resin may include 0.5 to 7 parts by weight of the coupling agent on the basis of 100 parts by weight of the unsaturated polyester resin. It is advantageous to improve bonding force with the inorganic particles and/or quartz powder when the coupling agent is included in an amount of 0.5 parts by weight or more, and it is advantageous to lower the cost of raw materials when it is included in an amount of 7 parts by weight or less.

### Inorganic Particles

In an exemplary embodiment of the present invention, the inorganic particles refer to inorganic particles having a particle size of 0.1 mm to 5.0 mm. The inorganic particles may include two or more types of inorganic particles having different particle sizes, for example, first inorganic particles having a particle size of 0.1 mm or greater and less than 0.3 mm, and second inorganic particles having a particle size of 0.3 mm or greater and 0.7 mm or less, but is not necessarily limited thereto.

In an exemplary embodiment of the present invention, the inorganic particles may include large inorganic particles having a particle size of greater than 1.18 mm, and may include large inorganic particles having a particle size of greater than 1.18 mm and 5.0 mm or less. In the related art, when manufacturing an artificial marble by applying large inorganic particles having a particle size of greater than 1.18 mm, both the content of the binder resin that holds the large particles and the content of the quartz powder that fills the space should be increased. Accordingly, the content of large inorganic particles having a particle size of greater than 1.18 mm is relatively reduced, and a gap between the large inorganic particles having a particle size of greater than 1.18 mm is increased, making it difficult to manufacture a natural pattern in which large particles are connected. However, in the present invention, even when large inorganic particles having a particle size of greater than 1.18 mm is applied, the gap between the inorganic particles having a particle size of greater than 1.18 mm is narrowed, making it possible to manufacture an artificial marble including a large chip-shaped pattern found in natural stones.

In addition to the large inorganic particles, the inorganic particles may include inorganic particles having a particle size of 0.1 mm or greater and 1.18 mm or less. Preferably, the inorganic particles may be used in combination with inorganic particles having a particle size of 0.1 mm or greater and less than 0.3 mm, 0.3 mm or greater and less than 0.7 mm, 0.7 mm or greater and 1.18 mm or less, or the like.

The large inorganic particles are distinguished from the inorganic particles based on the outermost interface, which is distinct in appearance. Based on the outermost interface, the large inorganic particles may have the same properties as a whole particle or, conversely, may have different properties, such as multiple interfaces or colors within the particle.

For example, when a quartz mineral is collected from a single stone species and then granulated into particles with a size of greater than 1.18 mm, all large inorganic particles may have the same properties. For example, when existing E-stone is broken down and recycled into large inorganic particles, even if the size of each recycled particle is included in the large inorganic particle category, the particles may not have a single composition and may have different colors such as separate patterns within the particles.

The inorganic particles may be mineral particles such as feldspar, quartz, and aluminum hydroxide, or may include, as highly transparent inorganic particles, one or more selected from amorphous silica particles, glass particles, and crystalline quartz particles.

Preferably, the highly transparent inorganic particles are amorphous silica particles, glass particles containing barium ions, and/or crystalline quartz particles having a SiO₂ content of 99.5 wt % to 100 wt %. Preferably, the inorganic particles of the present invention are amorphous silica particles, glass particles having a barium (Ba) ion content in the particle of 10 wt % to 35 wt %, and/or crystalline quartz particles having a SiO₂ content of 99.5 wt % to 100 wt %. More preferably, the inorganic particles of the present invention are amorphous silica particles and glass particles having a barium (Ba) ion content in the particle of 10 wt % to 35 wt %.

In an exemplary embodiment, an artificial marble manufactured using, as the inorganic particles, amorphous silica particles or glass particles having a barium (Ba) ion content in the particle of 10 wt % to 35 wt % has light transmittance higher than that of an artificial marble manufactured using, as the inorganic particles, crystalline quartz particles having a SiO₂ content of 99.5 wt % to 100 wt %. In addition, an artificial marble manufactured using, as the inorganic particles of the present invention, amorphous silica particles or glass particles having a barium (Ba) ion content in the particle of 10 wt % to 35 wt % has luminance higher than that of an artificial marble manufactured using, as the inorganic particles, crystalline quartz particles having a SiO₂ content of 99.5 wt % to 100 wt %.

In an exemplary embodiment of the present invention, the inorganic particles may be amorphous silica particles. The silica particles are a term commonly used in the field of artificial marble, and generally refers to SiO₂-based inorganic particles having a high SiO₂ content of 90 wt % or more, and including small amounts of other components such as minerals, in addition to SiO₂. The amorphous silica particles of the present invention may be amorphous fused silica particles, and the amorphous silica particles of the present invention may also be referred to as highly transparent amorphous fused silica particles in the present specification. In addition, the amorphous fused silica particles have a SiO₂ content of 99.5 wt % to 100 wt %, preferably 99.6 wt % to 100 wt %, and more preferably 99.7 wt % to 100 wt %. In addition, the amorphous fused silica particles may have an alumina content of 0.5 wt % or less, preferably 0.4 wt % or less, more preferably 0.3 wt % or less, and even more preferably 0.2 wt % or less. When the SiO₂ content in the amorphous silica particles is 99.5 wt % or more, preferably 99.6 wt % or more, and more preferably 99.7 wt % or more, the light transmittance of the artificial marble is further improved.

The SiO₂ content of the amorphous silica particles and crystalline quartz particles of the present invention may be confirmed by quantitatively analyzing the content with XRF(X-Ray Fluorescence spectroscopy). In addition, crystalline particles and amorphous particles can be confirmed by XRD (X-ray diffraction). XRF can be generally measured and confirmed after making particles into pellets, and XRD can be measured and confirmed in a particle or artificial marble state.

In an exemplary embodiment of the present invention, the inorganic particles may be glass particles containing barium ions. The glass particles of the present invention preferably have a barium (Ba) ion content in the particle of 10 wt % to 35 wt %, and more preferably 15 wt % to 25 wt %.

Since glass is amorphous, the glass particles containing barium ions of the present invention may also be referred to as highly transparent amorphous glass particles in the present specification. In this case, when high transparency means that the transmittance of visible ray is 90% to 100%, and specifically, means having a transmittance of 90% or greater in the visible ray region as measured by a UV/VIS spectrophotometer on a glass plate-shaped basis before being pulverized into particles.

The content of barium ions in the glass particles can be measuring by X-ray scan. The content of barium (Ba) ions in the glass particles when measured by X-ray scan is preferably 10 wt % to 35 wt %, and more preferably 15 wt % to 25 wt %. Even when the content of barium ions deviates from the above range, the transparency of the glass particles themselves is good, but if an artificial marble is manufactured using the glass particles, the artificial marble may appear bluish or greenish (jade green) to the naked eye, making it unsuitable for use. That is, when an artificial marble is made using glass particles having a content of barium (Ba) ions of 10 wt % to 35 wt % when measured by X-ray scan by weight, the artificial marble with good product quality and good color without bluish or greenish color can be manufactured.

The content of barium ions in artificial marble can be confirmed by XRF(X-Ray Fluorescence spectroscopy).

The presence or absence of barium can be easily determined using X-ray imaging. An exemplary embodiment of the present invention provides an artificial marble appearing bluish when irradiated with X-rays. The X-ray irradiation may be performed by, for example, an X-ray scanner available from Rapiscan. Here, blue is a color that is observed when observed with the naked eye. For example, ‘being bluish’ includes a case in which when an artificial marble to be measured is irradiated with X-rays, the artificial marble is relatively bluish, as compared with an artificial marble of a comparison target (i.e., an artificial marble consisting of one or two of a fused silica raw material, fused silica and mineral quartz and a binder) irradiated with X-rays under the same conditions.

In addition, the particles may be highly transparent glass particles having a transmittance of 90% or greater in the visible ray region as measured by a UV/VIS spectrophotometer on a glass plate-shaped basis before being pulverized into particles.

The inorganic particles of the present invention may be crystalline quartz particles. The crystalline quartz particles of the present invention may also be referred to as highly transparent crystalline quartz particles in the present specification.

In this case, the crystalline quartz particles may be highly transparent crystalline quartz particles, and also have a SiO₂ content of 99.5 wt % to 100 wt %, preferably 99.6 wt % to 100 wt %, and more preferably 99.7 wt % to 100 wt %. In addition, the crystalline quartz particles may have an alumina content of 0.5 wt % or less, preferably 0.4 wt % or less, more preferably 0.3 wt % or less, and even more preferably 0.2 wt % or less.

When the SiO₂ content in the crystalline quartz particles is less than 99.5 wt %, for example, 99.4 wt % or less, the light transmittance of the artificial marble may be lowered. Therefore, crystalline quartz particles having a SiO₂ content of 99.5 wt % or more are preferable. The particle size may be measured using a particle size analyzer (Beckman Coulter LS 13 320 particle size analyzer)

### Inorganic Powder

In an exemplary embodiment of the present invention, the composition includes inorganic powder. In this case, the inorganic powder means inorganic powder with a particle size of less than 0.1 mm. For example, the inorganic powder may include either or both of powder with a particle size of less than 55 μm and powder with a particle size of 55 μm or greater and less than 0.1 mm.

The particle size may be measured using a particle size analyzer (Beckman Coulter LS 13 320 particle size analyzer). The inorganic powder of the present invention may also be referred to as highly transparent crystalline quartz powder in the present specification.

The inorganic powder of the present invention may be crystalline inorganic powder or amorphous inorganic powder. Preferably, the inorganic powder may be crystalline powder or amorphous inorganic powder having a SiO₂ content of 99.5 wt % to 100 wt %. The inorganic powder of the present invention may be quartz powder. In addition, the inorganic powder of the present invention may have a SiO₂ content of 99.5 wt % to 100 wt %, preferably 99.6 wt % to 100 wt %, and more preferably 99.7 wt % to 100 wt %, and an alumina content of 0.5 wt % or less, preferably 0.4 wt % or less, more preferably 0.3 wt % or less, and even more preferably 0.2 wt % or less.

The crystalline quartz powder of the present invention preferably has an average SiO₂ content of 99.5 wt % to 100 wt % and an average alumina content of 0.5 wt % or less.

The SiO₂ content of the crystalline quartz powder of the present invention can be confirmed by quantitatively analyzing the content with XRF(X-Ray Fluorescence spectroscopy). In this case, the powder is generally made into pellets, which are then measured and confirmed with respect to the content.

Since the crystalline quartz powder has a small particle size, self-scattering occurs. Therefore, in order to increase the internal light transmittance of the artificial marble, the artificial marble of the present invention may include crystalline quartz powder having a SiO₂ content of 99.5 wt % or more. If the SiO₂ content of the crystalline quartz powder is less than 99.5 wt %, the internal light transmittance of the artificial marble is low, making it difficult to manufacture an artificial marble having high light transmittance.

### Solid Powder Resin

A melting temperature of the solid powder resin may be 50° C. or higher, 60° C. or higher, or 70° C. or higher. In addition, the melting temperature of the solid powder resin may be 130° C. or lower, 125° C. or lower, or 120° C. or lower.

A glass transition temperature (Tg) of the solid powder resin may be 40° C. or higher, or 50° C. higher. In addition, the glass transition temperature (Tg) of the solid powder resin may be 70° C. or lower, or 65° C. or lower.

A temperature at which curing of the solid powder resin begins may be 118° C. or higher, or 120° C. or higher. In addition, the temperature at which curing of the solid powder resin begins may be 135° C. or lower, or 130° C. or lower.

The solid powder resin may be a thermosetting powder resin. That is, the solid powder resin is present as powder in a stable state without reacting at room temperature, and when heat is applied to the solid powder resin, the solid powder resin melts and acts as a binder to hold inorganic substances included in the composition.

The solid powder resin may include one or more selected from an epoxy acrylate resin, a glycidyl methacrylate resin, a butyl methacrylate resin, a methyl methacrylate resin, a saturated polyester resin, a copolymer resin formed by polymerizing a methyl methacrylate resin and glycidyl methacrylate, a copolymer resin formed by polymerizing a methyl methacrylate resin and an epoxy acrylate resin, a polyester epoxy hybrid resin, and a resin in which polyester and glycidyl isocyanurate are mixed.

An average particle size of the solid powder resin may be 5 μm to 60 μm, or around 30 μm. In addition, the solid powder resin may undergo a curing reaction when heat is applied at temperature of 130° C. or higher for 10 minutes or longer.

In an exemplary embodiment of the present invention, the solid powder resin and the inorganic particles may be mixed with each other at a weight ratio of 1:1.

In an exemplary embodiment of the present invention, based on a total weight of the composition, the content of the liquid resin may be 7 wt % to 12 wt %, the content of the solid powder resin may be 8 wt % to 14 wt %, the content of the inorganic particles may be 45 wt % to 55 wt %, and the content of the inorganic powder may be 25 wt % to 35 wt %. More preferably, the content of the liquid resin may be 8 wt % to 11 wt %, the content of the solid powder resin may be 9 wt % to 13 wt %, the content of the inorganic particles may be 48 wt % to 52 wt %, and the content of the inorganic powder may be 27 wt % to 33 wt %.

In an exemplary embodiment of the present invention, an Avalanche Energy value of the composition may be 18 mJ/Kg or less.

The Avalanche energy value may be measured using dynamic powder flowability measurement equipment, and the lower the avalanche energy value, the better the flowability of the composition can be determined.

The resin compositions for a pattern of the related art have an Avalanche energy value of around 36 mJ/Kg. That is, due to the low flowability of the resin compositions for a pattern of the related art, there is a problem in that the discharge equipment is clogged or discharge defects occurs during the discharge process of the resin composition for a pattern. However, the resin composition for a pattern according to an exemplary embodiment of the present invention includes both the liquid resin including an unsaturated polyester resin and the solid powder resin and at the same time, satisfies the content ranges of the components constituting the resin composition for a pattern described above, so that it is possible to exhibit high flowability characteristics with an Avalanche Energy value of 18 mJ/Kg or less.

In an exemplary embodiment of the present invention, the Avalanche Energy value may be 18 mJ/Kg or less, or may be 15 mJ/Kg or less, and the lower limit is not particularly limited.

The dynamic powder flowability measurement equipment may be Rev2015 (Marktech Trading Co., Ltd.), but is not limited thereto. The dynamic powder flowability measurement equipment may include a main body that measures flowability, a sample cup that can measure a weight of a mixture, and a sample drum that can contain the mixture and can be placed into the main body, and a weight of the mixture that can be contained in the sample cup may be 80 g to 120 g. The Avalanche Energy value can be measured at room temperature using the dynamic powder flowability measurement equipment described above.

### Inorganic Pigment

In an exemplary embodiment of the present invention, the resin composition for a pattern may further include an inorganic pigment. The inorganic pigment may be any inorganic pigment known in the art, and is not particularly limited. For example, the inorganic pigment may include one or more selected from TiO₂, NiO·Sb₂O₃·20TiO₂, Fe₂O₃, and Fe₃O₄, but is not limited thereto.

The inorganic pigment may be gently mixed so as not to be distributed homogeneously in the resin composition for a pattern. As the inorganic pigment is non-uniformly present in this way, a pattern may be maintained to be transparent, and a region including a pattern has a more transparent appearance due to the inorganic pigment.

In this case, in order to manufacture a pattern with various colors, a plurality of resin compositions for a pattern to which inorganic pigments capable of exhibiting respective colors are applied can be used.

In an exemplary embodiment of the present invention, the inorganic particles and the inorganic pigment may be mixed with each other at a weight ratio of 1:1.

In an exemplary embodiment of the present invention, after the step of discharging the resin composition for a pattern into the engraved pattern, a vibration and compression process is performed, and then a thermal curing process is performed to produce an artificial marble including a base region and a pattern region.

Through the vibration and compression process, a solid phase with a pattern is established, and then through the thermal curing process, the solid powder resin is melted and converted into a liquid resin, which can be then cured. In particular, the liquid resin obtained by melting the powder resin can serve to connect spaces between the inorganic particles, and since the liquid resin obtained by melting the powder resin is transparent, the liquid resin may exhibit a shape of the inorganic particles connected to each other as a whole.

In an exemplary embodiment of the present invention, the vibration and compression process may use processes known in the art. For example, the vibration and compression process may be performed in such a manner that based on manufacturing a slab of 3.300 mm×1,650 mm×(20 to 30) mm in size, vibration compression is initially performed at 2,500 to 2,800 rpm for 10 to 20 seconds, then the speed is continuously increased to 2,800 to 3,250 rpm, and vibrator pressing is performed for 40 to 50 seconds. In this case, the pressure may be set to about 1.5 bar, which is within a range that does not damage the vibrator. The vibration and compression process may be performed as described above, but is not limited thereto.

The thermal curing process may be performed at temperature of 118° C. or higher for 10 minutes or longer. Through the thermal curing process, the solid powder resin of the resin composition for a pattern is melted and converted into liquid resin, which can be then cured. Therefore, in an exemplary embodiment of the present invention, the melting and curing processes of the solid powder resin may be performed simultaneously.

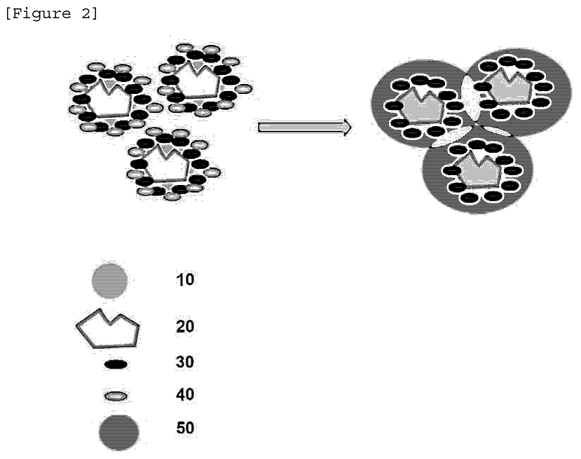

In the method for manufacturing an E-stone based artificial marble of the present invention, the thermal curing process is schematically shown in FIG. 2. As shown in FIG. 2, a composition according to the present invention may include a liquid resin 10; a solid powder resin 40; an inorganic particle 20; and inorganic powder 30, and the solid powder resin 40 may be melted and converted into liquid resin 50 through a thermal curing process, which may be then cured.

A method for manufacturing an E-stone based artificial marble according to an exemplary embodiment of the present invention may include a step of removing the mold after forming an artificial marble including the base region and the pattern region; and a post-processing step of cutting the artificial marble and polishing a surface to be smooth. The method for removing the mold, the post-processing method, and the like are not particularly limited, and methods known in the art may be used.

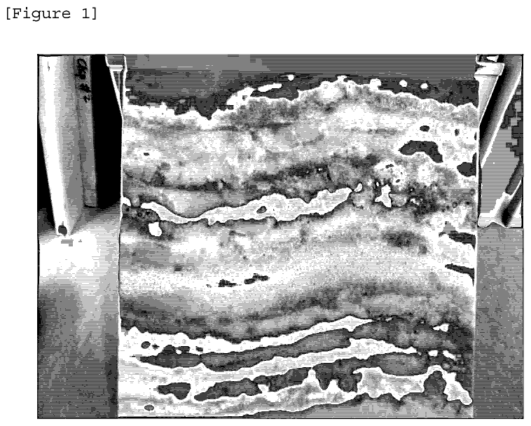

In addition, an exemplary embodiment of the present invention provides an E-stone based artificial marble manufactured by the manufacturing method of an artificial marble. An artificial marble according to an exemplary embodiment of the present invention is shown in FIG. 1.

The E-stone based artificial marble according to an exemplary embodiment of the present invention can stably implement a pattern with a width of less than 2 cm and a length of 5 cm or longer.

In addition, the method for manufacturing an E-stone based artificial marble according to an exemplary embodiment of the present invention can form a natural flow pattern in the artificial marble by forming an engraved pattern on the base layer and discharging a resin composition for a pattern into the engraved pattern.

In addition, according to an exemplary embodiment of the present invention, the resin composition for a pattern includes both a liquid resin and a solid powder resin and satisfies the characteristic of an Avalanche Energy value of 18 mJ/Kg or less, so that flowability of the resin composition for a pattern can be improved, problems such as clogging of discharge equipment and discharge defects that may occur when discharging the resin composition for a pattern can be solved, and occurrence of pinholes when forming a pattern of artificial marble can be suppressed.

In manufacturing the artificial marble as described above, compositions of the resin composition for a base and the resin composition for a pattern may be different from each other. Preferably, the pigments or binder resins in the compositions may be different from each other, and more preferably, the binder resins may be different from each other. In addition, the meaning of being different may mean that the content is different, including the presence or absence of the composition. The difference in content is beyond a level of error tolerated in the art, and for example, may refer to a difference of 10% or more, preferably 5% or more. If it is difficult to absolutely distinguish the difference in content, relative comparison can be made with a resin composition for a base and a resin composition for a pattern prepared identically using a device that can perform measurement under the same conditions. As an example, relative content comparison may be made by comparing areas using GC (gas chromatography), which does not perform quantitative analysis. In this case, if a difference in area is 5% or more, it can be said that there is a difference in content.

The resin composition for a base is distributed throughout the pattern frame, and the resin composition for a pattern, a composition suitable for discharge through a narrow inlet may be selected. Using the resin composition for a pattern only for some patterns does not have a significant effect on the physical properties of artificial marble, but using the same resin composition for a pattern for all patterns may not preferable because there may be problems with the physical properties, and binder may be additionally used to thus increase the process, which is not also suitable in terms of cost.

In addition, another exemplary embodiment of the present application provides an E-stone based artificial marble wherein the E-stone based artificial marble has a flexural strength of 2,000 kgf/cm² or higher as measured according to ASTM C170, wherein the inorganic particles include large inorganic particles with a particle size of greater than 1.18 mm and inorganic particles with a particle size of 1.18 mm or less, and wherein the E-stone based artificial marble includes a region in which, when a sample of at least 5 g of the E-stone based artificial marble is collected and subjected to organic substance removal, washing and drying according to ASTM D2584 (Ash test) and then a remaining inorganic substance is sufficiently sieved out through a 1.18 mm sieve (ASTM E-11, No. 16), a volume ratio of A in Mathematical Formula 2 below is 50% or more or Mathematical Formula 3 below is satisfied where A is a material remaining on the top after the sieving and B is a material having passed through the sieve.

$$Volume ratio of A = {V}_{A} / ( {V}_{A} + {V}_{B} ) \times 100 = 1 / [ 1 + ( {ρ}_{A} / {p}_{B} ) \cdot ( {m}_{B} / {m}_{A} ) ] \times 100 \qquad [ Mathematical Formula 2 ]$$

$${ρ}_{A} / {ρ}_{B} < {m}_{A} / {m}_{B} \qquad [ Mathematical Formula 3 ]$$

in Mathematical Formulas 2 and 3,
V_{A} is a volume of A and V_{B} is a volume of B,
ρ_{A} is a specific gravity of A and ρ_{B} is a specific gravity of B, and
m_{A} is a weight of A and m_{B} is a weight of B.

In this case, the region that satisfies Mathematical Formula 2 may be at least (2 cm×2 cm).

In addition, A may be a large inorganic particle with a particle size of greater than 1.18 mm, and B may be an inorganic particle with a particle size of 0.1 mm or greater and 1.18 mm or less and inorganic powder with a particle size of less than 0.1 mm.

The flexural strength of 2,000 kgf/cm² or higher as measured according to ASTM C170 is the minimum physical property for application as an E-stone based artificial marble, and if the flexural strength is less than 2,000 kgf/cm², the corresponding artificial marble cannot be applied as an E-stone based artificial marble.

The E-stone based artificial marble according to an exemplary embodiment of the present invention can be manufactured by simultaneously applying the liquid resin and the solid powder resin, whereby gaps between large inorganic particles with a particle size of greater than 1.18 mm can be narrowed. Accordingly, an artificial marble including a large chip-shaped pattern or a large chip-shaped vein pattern found in natural stones can be manufactured.

In addition, another exemplary embodiment of the present invention provides a method for manufacturing an E-stone based artificial marble, the method including: manufacturing an artificial marble composition including a liquid resin, an inorganic particle with a particle size of greater than 1.18 mm, an inorganic particle with a particle size of 0.1 mm or greater and 1.18 mm or less, inorganic powder with a particle size of less than 0.1 mm, and a solid powder resin; and forming an artificial marble by putting the artificial marble composition into a mold, performing a vibration and compression process, and then performing a thermal curing process.

In an exemplary embodiment of the present invention, when applying inorganic particles having a particle size of greater than 1.18 mm, a total content of the liquid resin and solid powder resin may be 8 wt % or more, or 15 wt % or more, and may be 23 wt % or less, based on the total weight of the artificial marble composition. Based on the total weight of the artificial marble composition, if the total content of the liquid resin and solid powder resin is less than 8 wt %, the resin content is low, so it is difficult to obtain a product in the form of transparent particles attached thereto, and sufficient binding is not achieved during a heat treatment process after applying a high pressure, resulting in pinholes. In addition, based on the total weight of the artificial marble composition, if the total content of the liquid resin and solid powder resin exceeds 23 wt %, the quartz powder and solid powder may adhere to surfaces of the inorganic particles, forming a large paste. Formation of such a paste with poor flowability is undesirable because belt transfer and molding may be difficult during the process.

### MODE FOR INVENTION

Below, Examples will be described in detail to specifically describe the present invention. However, the Examples according to the present invention may be modified in other forms, and the scope of the present invention is not construed as being limited to the following Examples. The Examples of the present invention are provided to more completely explain the present invention to one skilled in the art.

### EXAMPLES

### Example 1

Inorganic particles with a particle size of 0.1 mm to 4.0 mm (quartz sand available from Sibelco) and liquid resin (unsaturated polyester resin available from Polynt, U.S.A.) were mixed uniformly for 1 minute. Thereafter, quartz powder with a particle size of 45 μm or less (quartz powder available from Sibelco) was added and mixed repeatedly twice for 1 minute. Finally, solid powder resin (Akzonobel, acrylic powder resin) was added and mixed for 60 to 120 seconds to prepare a resin composition for a pattern.

In the resin composition for a pattern, the contents of the liquid resin, solid powder resin, inorganic particles, and quartz powder are shown in Table 1 below.

### Examples 2 and 3 and Comparative Examples 1 to 4

As shown in Table 1 below, the same procedure as in Example 1 was performed, except that the contents of the liquid resin, solid powder resin, inorganic particles, and quartz powder were adjusted.

TABLE 1

| | Content (parts by weight) | | | |
|---|---|---|---|---|
| | Liquid | Solid powder | Inorganic | Quartz |
| | resin | resin | particles | powder |
| Example 1 | 8 | 12 | 50 | 30 |
| Example 2 | 8.5 | 12 | 50 | 29.5 |
| Example 3 | 9 | 12 | 50 | 29 |
| Comparative | 14 | — | 50 | 36 |
| Example 1 | | | | |
| Comparative | 5 | 17 | 48 | 30 |
| Example 2 | | | | |
| Comparative | 7.5 | 17 | 50 | 25.5 |
| Example 3 | | | | |
| Comparative | 7.5 | 7 | 60 | 25.5 |
| Example 4 | | | | |

### <Experimental Example 1> Evaluation of Resin Composition for Pattern

The Avalanche Energy values of the resin compositions for a pattern prepared in the Examples and Comparative Examples were measured and shown in Table 2 below. The Avalanche energy value was measured using dynamic powder flowability measurement equipment (Rev2015, Marktech Trading Co., Ltd.). In addition, the quality of the resin compositions for a pattern prepared in the Examples and Comparative Examples was evaluated and shown in Table 2 below.

TABLE 2

| | Avalanche energy value | |
|---|---|---|
| | (mJ/Kg) | Quality |
| Example 1 | 12.80 | OK |
| Example 2 | 12.60 | OK |
| Example 3 | 13.20 | OK |
| Comparative | 36.00 | NG |
| Example 1 | | |
| Comparative | 13.11 | NG |
| Example 2 | | |
| Comparative | 29.34 | OK |
| Example 3 | | |
| Comparative | 13.77 | NG |
| Example 4 | | |

The quality evaluation in Table 2 was performed based on whether the pattern layers prepared from the resin compositions for a pattern according to the Examples and Comparative Examples had a quality equivalent to that of the base layer of artificial marble, which will be described below. More specifically, a case where the pattern layer was completely cured without a pinhole, a crack, and an uncured region was evaluated as “OK,” and a case where any of the pinhole, crack, and uncured region characteristics was not satisfied was evaluated as “NG.”

As the content of the solid powder resin increases, flowability may improve. However, according to the results of Comparative Example 2, it can be confirmed that the quality of the vein pattern layer of artificial marble is evaluated as “NG” because the content range of the liquid resin as in the present invention is not satisfied.

In addition, in Comparative Example 3 where the Avalanche energy value was above 18 mJ/Kg, a phenomenon that the solid powder resin agglomerated occurred during the preparation of the resin composition for a pattern, and accordingly, when forming a pattern of artificial marble, a phenomenon occurred in which the pattern forming composition was not discharged from the discharge machine.

Therefore, the resin composition for a pattern according to an exemplary embodiment of the present invention adjusts the contents of the liquid resin and solid powder resin so as to satisfy the characteristic of an Avalanche Energy value of 18 mJ/Kg or less, making it possible to improve not only the flowability of the resin composition for a pattern but the quality of the pattern of the artificial marble to be manufactured.

In addition, by improving the flowability of the resin composition for a pattern, problems such as clogging of the discharge equipment and discharge defects that may occur when discharging the resin composition for a pattern can be improved, and the discharge equipment can be easily cleaned.

### <Experimental Example 2> Preparation of Artificial Marble

### 1) Preparation of Composition for Base

Inorganic particles with a particle size of 0.1 mm to 4.0 mm (quartz sand available from Sibelco) and liquid resin (unsaturated polyester resin available from Polynt, U.S.A.) were mixed uniformly for 1 minute. Thereafter, quartz powder with a particle size of 45 μm or less (quartz powder available from Sibelco) was added and mixed repeatedly twice for 1 minute to prepare a resin composition for a base.

At this time, based on the total weight of the resin composition for a base, 14 wt % of liquid resin, 47 wt % of inorganic particles, and 39% of quartz powder were used.

### 2) Preparation of Artificial Marble

The resin composition for a base was put into a rubber mold, and an engraved pattern was formed using an emboss plate for pattern preparation. After putting the resin composition for a pattern prepared in the Examples or Comparative Examples into the engraved pattern, a vibration and compression process was performed. At this time, the vibration and compression process was performed in such a manner that vibration compression was initially performed at 2,500 rpm for 20 seconds, then the speed was continuously increased to 2,600 rpm, and vibrator pressing was performed for 50 seconds.

Then, the resin composition was cured at 120° C. or higher for 1 hour, and after the curing was completed, the cured composition was cooled to room temperature, and then taken out of the mold to prepare an artificial marble. After cutting the artificial marble on all sides, the surfaces were polished smoothly to prepare an artificial marble with a pattern.

When the resin compositions for a pattern according to Examples 1 to 3 of the present invention were applied, the compositions for pattern formation were smoothly discharged from the discharge machine during the pattern formation. However, when the artificial marble compositions for a vein pattern of Comparative Examples 1 and 3, where the Avalanche energy value was above 18 mJ/Kg, were applied, the compositions for vein pattern formation were not smoothly discharged from the discharge machine during the vein pattern formation, causing the problem that the discharge machine was clogged.

In addition, in the artificial marbles prepared by applying the resin compositions for a pattern of Examples 1 to 3, the width of the pattern was less than 2 cm on average and the length of the pattern was 5 cm or longer on average. Therefore, the configuration according to the present invention makes it possible to form a pattern with a thin width of less than 2 cm and a length of up to 300 cm or longer when applied to a product of 3.300 mm×1,650 mm×(20 to 30) mm in size.

### Example 4

### 1) Preparation of Composition for Base

Inorganic particles obtained by mixing first inorganic particles (quartz sand) with a particle size of 0.1 mm to 0.3 mm and second inorganic particles (quartz sand) with a particle size of 0.3 mm to 0.7 mm at a weight ratio of 1:2.5 and a liquid resin (unsaturated polyester resin, Polynt, U.S.A.) were mixed uniformly for 1 minute. Thereafter, quartz powder with a particle size of 45 μm or less (quartz powder available from Sibelco) was added and mixed repeatedly twice for 1 minute to prepare a composition for a base.

At this time, based on the total weight of the composition for a base, 12 wt % of liquid resin, 57 wt % of inorganic particles, and 31 wt % of quartz powder were used.

### 2) Preparation of Artificial Marble Composition for Vein Pattern

After mixing first inorganic particles (quartz sand) with a particle size of 0.1 mm to 0.3 mm and second inorganic particles (quartz sand) with a particle size of 0.3 mm to 0.7 mm, a white inorganic pigment (TiO₂) was added and mixed uniformly for 1 minute. Thereafter, an unsaturated polyester resin was added and mixed uniformly for 1 minute, and quartz powder with a particle size of 45 μm or less (quartz powder available from Sibelco) was added and mixed repeatedly twice for 1 minute. Finally, a solid powder resin was added and mixed for 2 minutes to prepare an artificial marble composition for a vein pattern. For the solid powder resin, a solid powder resin having the glass transition temperature of 53° C. and the melting temperature of 119° C., undergoing the curing reaction beginning at 123° C. and ending at 180° C., and having the maximum exothermic temperature of 166° C. was applied.

At this time, based on the total weight of the artificial marble composition for a vein pattern, 6.4 wt % of liquid resin, 17.8 wt % of first inorganic particles, 39.3 wt % of second inorganic particles, 1 wt % of inorganic pigment, 28.3 wt % of quartz powder, and 7.2 wt % of solid powder resin were used.

### 3) Preparation of Artificial Marble

The composition for a base was put into a rubber mold with a width of 300 mm, a length of 300 mm, and a height of 18 mm, and the surface was compacted by pressing it with a roller. Thereafter, an engraved pattern with a width of 15 mm and a length of 300 mm was formed using a spatula. After the artificial marble composition for a vein pattern prepared above was added to the engraved pattern, it was compacted by applying vibration and pressure at 2,900 rpm for 1 minute using a vibrator press.

The compacted mixture was placed between upper and lower heating plates heated to 130° C., which was then compressed from the top and bottom with a force of 1 atm or less and heated for 50 minutes.

After curing was completed, the mixture was cooled to room temperature and then taken out from the mold to prepare an artificial marble. After cutting the artificial marble on all sides, the surfaces were polished smoothly to prepare an artificial marble with a vein pattern.

As a result of checking the prepared artificial marble, it could be confirmed that a vein pattern with a width of 15 mm and a length of 300 mm and having a smooth surface was prepared.

### Example 5

The same procedure as in Example 4 was performed, except that a solid powder resin having the glass transition temperature of 57° C. and the melting temperature of 60° C., undergoing the curing reaction beginning at 128° C. and ending at 180° C., and having the maximum exothermic temperature of 172° C. during curing was applied.

As a result of checking the prepared artificial marble, it could be confirmed that a vein pattern with a width of 15 mm and a length of 300 mm and having a smooth surface was prepared.

### Example 6

The same procedure as in Example 4 was performed, except that a solid powder resin having the glass transition temperature of 63° C. and the melting temperature of 67° C., undergoing the curing reaction beginning at 121° C. and ending at 182° C., and having the maximum exothermic temperature of 174° C. during curing was applied.

As a result of checking the prepared artificial marble, it could be confirmed that a vein pattern with a width of 15 mm and a length of 300 mm and having a smooth surface was prepared.

### Example 7

The same procedure as in Example 4 was performed, except that a solid powder resin having the glass transition temperature of 51° C. and the melting temperature of 116° C., undergoing the curing reaction beginning at 118° C. and ending at 182° C., and having the maximum exothermic temperature of 169° C. during curing was applied.

As a result of checking the prepared artificial marble, it could be confirmed that a vein pattern with a width of 15 mm and a length of 300 mm and having a smooth surface was prepared.

### Example 8

The same procedure as in Example 4 was performed, except that the liquid resin was 10.4 wt % and the solid powder resin was 3.2 wt %.

As a result of checking the prepared artificial marble, it could be confirmed that a vein pattern with a width of 15 mm and a length of 300 mm and having a smooth surface was prepared.

### Example 9

The same procedure as in Example 4 was performed, except that a solid powder resin having the glass transition temperature of 66° C. and the melting temperature of 69° C. and undergoing the curing reaction beginning at 160° C. and ending at 184° C. was applied.

In Example 9, the temperature at which curing of the solid powder resin began was too high, so it was observed that the surface of the vein pattern was not smooth and the inorganic particles easily fell off. Therefore, it can be confirmed that, in order for the vein pattern of artificial marble to have a smooth surface, the temperature at which the curing of the solid powder resin begins is more preferably 118° C. to 135° C.

### Comparative Example 5

The same procedure as in Example 4 was performed, except that a thermoplastic resin having the glass transition temperature of 86° C. and the melting temperature of 90° C. was applied as the solid powder resin. In Comparative Example 5, it could be confirmed that the liquid resin was separated during the thermal curing process, and boiling bubbles were generated due to heat during the reaction of the unsaturated polyester, resulting in a large number of bubbles being formed in the surface of the vein pattern.

### Comparative Example 6

The same procedure as in Example 4 was performed, except that a thermoplastic resin having the glass transition temperature of 101° C. and the melting temperature of 109° C. was applied as the solid powder resin.

In Comparative Example 6, it could be confirmed that the liquid resin was separated during the heat curing process, and boiling bubbles were generated due to heat during the reaction of the unsaturated polyester, resulting in a large number of bubbles being formed in the surface of the vein pattern.

### Comparative Example 7

The same procedure as in Example 4 was performed, except that a solid powder resin having the glass transition temperature of 48° C. and the melting temperature of 125° C. and undergoing the curing reaction beginning at 140° C. and ending at 180° C. was applied.

In Comparative Example 7, the solid powder resin did not completely melt and did not undergo the curing during the given curing time, resulting in a rough surface where a powder state could be touched by hand. Therefore, it can be confirmed that if the glass transition temperature of the solid powder resin is too low and the melting temperature is too high, the solid powder resin cannot sufficiently melt and thus cannot serve as a binder.

### Comparative Example 8

The same procedure as in Example 4 was performed, except that a solid powder resin having the glass transition temperature of 43° C. and the melting temperature of 55° C. and undergoing the curing reaction beginning at 105° C. and ending at 140° C. was applied.

In Comparative Example 8, the melting temperature of the solid powder resin was too low and the curing occurred too quickly, causing agglomeration due to instantaneous heat during the mixing process. In this case, a rough surface partially formed by hard agglomeration appeared inside the final cured vein pattern, which is called a dry spot. That is, it was observed that when melted at too low temperature, partial instantaneous curing occurred, which did not result in a normal surface condition.

As shown in the above results, the artificial marble composition according to an exemplary embodiment of the present invention includes both the liquid resin including an unsaturated polyester resin and the thermosetting solid powder resin, making it possible to manufacture an artificial marble in which pinholes do not occur in the vein pattern of artificial marble and which can implement a natural flow pattern.

In addition, according to an exemplary embodiment of the present invention, the thermosetting solid powder resin can serve as a binder for inorganic substances, thereby suppressing the occurrence of pinholes when forming a vein pattern of artificial marble.

### <Example 10> Application of Liquid Resin (8.5 wt %), Solid Powder Resin (11.5 wt %), and Inorganic Particles (Particle Size of Greater than 1.18 mm)

655 g of inorganic particles (quartz sand available from Sibelco, Megasil CS-0090) mixed with large inorganic particles with a particle size of greater than 1.18 mm was put into a white “U”-shaped plastic container and mixed at a speed of 15 rpm for 1 min by a rotary mixer having an alumina ceramic rod. Next, 85 g of liquid resin (unsaturated polyester resin available from Aekyung, ATM-1000) was added and mixed again at a speed of 15 rpm for 1 min by the same rotary mixer. At this time, the liquid resin was coated on the surface of the inorganic particles. Thereafter, 145 g of quartz powder improved in advance with an average particle size of 25 μm was poured and mixed again at an initial speed of 5 rpm for 15 seconds by the rotary mixer, and then mixed at the finally increased speed of 15 rpm for 2 minutes. At this time, quartz powder surrounds the surfaces of the inorganic particles coated with liquid resin and separates the particles from each other. Finally, 115 g of solid powder resin (Akzonobel, acrylic powder resin) was added and mixed at a speed of 15 rpm for 1 min.

The state of the mixture prepared in this way was a very dry state in which large particles were separated from each other and could roll around easily. Here, the expression ‘dry state’ means that when 50 g of large particles are placed on one hand and clenched by a fist, the particles do not agglomerate together like snow but crumble like powder and flow down between the fingers.

Thereafter, a rubber mold of 300 mm×300 mm×20 mm in size was divided into four parts and simple plastic walls were set up to make a space of 150 mm×150 mm×20 mm. The prepared mixture was poured into a ¼ space of the rubber mold and spread evenly. The remaining ¾ spaces were filled with other mixtures. The other mixtures may be mixtures of the Comparative Examples or other Examples. The mixture sprayed on the mold was covered with a rubber top plate and vibrated at an initial speed of 2,600 rpm for 30 seconds by a vibrator (available from Breton), and then beaten at the increased speed of 3,100 rpm for 120 seconds. At this time, the pressure was 1.5 bar. The highly compressed raw material was put into a heating plate oven where the upper and lower parts were heated simultaneously, and then cured for 50 minutes. At this time, both the temperatures of the upper and lower heating plates were 130° C. The cured slab was demolded from the rubber mold and cooled at room temperature of 25° C. for 30 minutes. Of the cooled slab, only the required mixture in the ¼ region was cut into 100 mm×100 mm using a water saw, which was then subjected to multiple polishing so as to be a thickness of 18 mm by a polisher, resulting in a specimen with a surface gloss of 60 or higher.

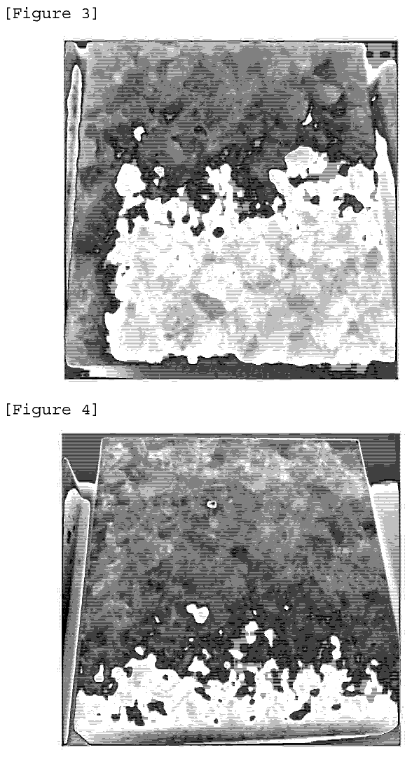

An artificial marble according to Example 10 is shown in FIG. 3. The artificial marble according to Example 10 showed an appearance similar to natural stone with large transparent glass particles tightly attached, and it could be confirmed that the surface was smooth and had no bubbles or cracks. Additionally, as a result of measuring the transmittance of Nippon Denshoku Industries, the transmittance was 4.2, which is twice higher than the general level of 2.0 in the related art.

The specific gravity of the inorganic particles (655 g) mixed with the large inorganic particles with a particle size of greater than 1.18 mm was 2.65, and the specific gravity of the quartz powder (145 g) was 2.65.

When the inorganic particles (655 g) were sieved through a 1.18 mm sieve (ASTM E-11, No. 16), the weight of large inorganic particles greater than 1.18 mm remaining on the top of the sieve was 412 g. Accordingly, it could be confirmed that among the inorganic particles (655 g), the weight of the large inorganic particles with a particle size of greater than 1.18 mm was 412 g and the volume ratio was 63%.

In addition, among the inorganic particles and quartz powder, the weight of the large inorganic particles with a particle size of greater than 1.18 mm was 412 g, the weight of the inorganic particles with a particle size of 1.18 mm or less was 243 g, and the weight of the quartz powder was 145 g. Therefore, it could be confirmed that the volume ratio of large inorganic particles with a particle size of greater than 1.18 mm calculated according to Mathematical Formula 1 was 51.5%.

### <Example 11> Application of Liquid Resin (9.3 wt %), Solid Powder Resin (12.6 wt %), and Inorganic Particles (Particle Size of Greater than 1.18 mm)

The same procedure as in Example 10 was performed, except that 55 g of quartz powder was applied instead of 145 g.

In the artificial marble according to Example 11, transparent large particles in the same form as Example 10 were connected, and the transmittance measurement result increased to 6.10. In addition, the surface state of the artificial marble according to Example 11 was smooth and transparent.

In Example 11, it could be confirmed that the volume ratio of large inorganic particles with a particle size of greater than 1.18 mm, calculated in the same manner as in Example 10, was 58.0%.

### <Example 12> Application of Liquid Resin (6.2 wt %), Solid Powder Resin (8.4 wt %), and Inorganic Particles (Particle Size of Greater than 1.18 mm)

The same procedure as Example 10 was performed, except that 1,030 g of inorganic particles was applied instead of 655 g.

In the artificial marble according to Example 12, transparent large particles in the same form as Example 10 were connected, and the transmittance measurement result was 3.98, which was similar to that in Example 10.

In Example 12, it could be confirmed that the volume ratio of large inorganic particles with a particle size of greater than 1.18 mm, calculated in the same manner as in Example 10, was 55.1%.

### <Example 13> Application of Liquid Resin (6.2 wt %), Solid Powder Resin (14.5 wt %), and Inorganic Particles (Particle Size of Greater than 1.18 mm)

The same procedure as in Example 10 was performed, except that 1,080 g of inorganic particles was applied instead of 655 g, 200 g of powder resin was applied instead of 115 g, and 200 g of quartz powder was applied instead of 145 g.

In the artificial marble according to Example 13, transparent large particles in the same form as Example 10 were connected, and the transmittance measurement result was 5.81, which was similar to that in Example 11. As shown in the above results, it could be confirmed that even if the content of the liquid binder resin was lowered, when the content of the powder resin was increased, large particles could be held well and transmittance also increased.

In Example 13, it could be confirmed that the volume ratio of large inorganic particles with a particle size of greater than 1.18 mm, calculated in the same manner as in Example 10, was 53.1%.

### <Comparative Example 9> Application of Liquid Resin (14.9 wt %) and Inorganic Particles (Particle Size of Greater than 1.18 mm)

The same procedure as in Example 10 was performed, except that the solid powder resin was not applied, 160 g of the liquid resin was applied instead of 85 g, and 260 g of the quartz powder was applied instead of 145 g.

An artificial marble according to Comparative Example 9 is shown in FIG. 4. The artificial marble according to Comparative Example 9 had a high content of liquid resin of 14.9%, but also the increased content of quartz powder of 24.2%, showing the appearance of large transparent glass particles surrounded by opaque boundaries. Additionally, as a result of measuring the transmittance of Nippon Denshoku Industries, the transmittance was 1.85, showing poor transparency.

In Comparative Example 9, it could be confirmed that the volume ratio of large inorganic particles with a particle size of greater than 1.18 mm, calculated in the same manner as in Example 10, was 45.0%.

### <Comparative Example 10> Application of Liquid Resin (11.4 wt %) and Inorganic Particles (Particle Size of Greater than 1.18 mm)

The same procedure as in Comparative Example 9 was performed, except that 118 g of liquid resin was applied instead of 160 g.

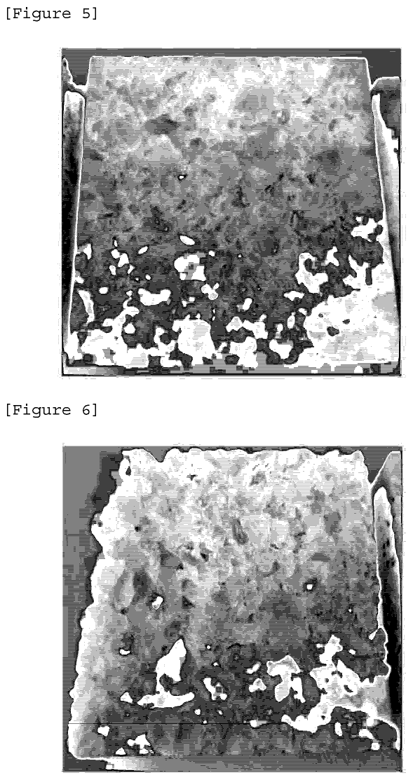

An artificial marble according to Comparative Example 9 is shown in FIG. 5. In the artificial marble according to Comparative Example 9, white opaque agglomerates were observed in the middle of large transparent glass particles, and it was confirmed that as a result of measuring the transmittance of Nippon Denshoku Industries, the transmittance was lowered to 1.06. In addition, the natural surface unique to artificial marbles disappeared and the appearance as if plastic were inserted was shown.

In Comparative Example 10, it could be confirmed that the volume ratio of large inorganic particles with a particle size of greater than 1.18 mm, calculated in the same manner as in Example 10, was 45.0%.

### <Comparative Example 11> Application of Liquid Resin (7.6 wt %) and Inorganic Particles (Particle Size of Greater than 1.18 mm)

The same procedure as in Comparative Example 9 was performed, except that 75 g of liquid resin was applied instead of 160 g.

An artificial marble according to Comparative Example 11 is shown in FIG. 6. In the artificial marble according to Comparative Example 11, cracks and pinholes were confirmed between large particles. In addition, as a result of measuring the transmittance of Nippon Denshoku Industries, the transmittance was 0.56, which was opaque, the solid shape of artificial marble was not taken.

### <Comparative Example 12> Application of Liquid Resin (5.5 wt %) and Inorganic Particles (Particle Size of Greater than 1.18 mm)

The same procedure as in Comparative Example 9 was performed, except that 53 g of liquid resin was applied instead of 160 g.

However, Comparative Example 12 had many voids, and had a weak flexural strength that could not be called E-stone.

### Comparative Example 13

The same procedure as in Example 10 was performed, except that the solid powder resin was not applied and 200 g of liquid resin was applied instead of 85 g.

However, in Comparative Example 13, a wet intermediate material was formed, making it impossible to form artificial marble using the existing process.

### Comparative Example 14

The same procedure as in Example 10 was performed, except that the solid powder resin was not applied and 56 g of liquid resin was applied instead of 85 g.

However, in Comparative Example 14, an artificial marble was prepared while maintaining the dry phase, but the particles of the prepared artificial marble were broken, so the shape of artificial marble could not be formed.

In Comparative Example 14, it could be confirmed that the volume ratio of large inorganic particles with a particle size of greater than 1.18 mm, calculated in the same manner as in Example 10, was 51.5%.

TABLE 3

| | | | | | | Flexural | |
|---|---|---|---|---|---|---|---|
| | | | | | | strength | |
| | | | | | | of E- | |
| | Weight | Weight | | | | stone | |
| | and | and | | | | (2,000 | |
| | volume | volume | | | Solid | kgf/cm² | |
| | ratio | ratio | Liquid | | power | or | |
| | of A | of B | resin | | resin | higher) | Remarks |
| Example | 412 g | 388 g | 85 | g | 115 g | ◯ | |
| 10 | 51.5% | 48.5% | | | | | |
| Example | 412 g | 298 g | 85 | g | 115 g | ◯ | |
| 11 | 58.0% | 42.0% | | | | | |
| Example | 648 g | 527 g | 85 | g | 115 g | ◯ | |
| 12 | 55.1% | 44.9% | | | | | |
| Example | 680 g | 600 g | 85 | g | 115 g | ◯ | |
| 13 | 53.1% | 46.9% | | | | | |
| Compar- | 412 g | 503 g | 160 | g | — | X | E-stone |
| ative | 45.0% | 55.0% | | | | | could not |
| Example | | | | | | | be formed |
| 9 | | | | | | | due to wet |
| | | | | | | | material |
| Compar- | 412 g | 503 g | 118 | g | — | ◯ | Wide |
| ative | 45.0% | 55.0% | | | | | spacing |
| Example | | | | | | | between |
| 10 | | | | | | | large |
| | | | | | | | inorganic |
| | | | | | | | particles |
| Compar- | 412 g | 503 g | 75 | g | — | X | Dry but |
| ative | 45.0% | 55.0% | | | | | broken, |
| Example | | | | | | | cracks and |
| 11 | | | | | | | pinholes |
| | | | | | | | occurred. |
| Compar- | 412 g | 503 g | 53 | g | — | X | Dry but |
| ative | 45.0% | 55.0% | | | | | broken, |
| Example | | | | | | | large |
| 12 | | | | | | | holes at |
| | | | | | | | the level |
| | | | | | | | of a void |
| | | | | | | | occurred. |
| Compar- | 412 g | 388 g | 160 | g | — | X | E-stone |
| ative | 51.5% | 48.5% | | | | | could not |
| Example | | | | | | | be formed |
| 13 | | | | | | | due to wet |
| | | | | | | | material |
| Compar- | 412 g | 388 g | 56 | g | — | X | Dry but |
| ative | 51.5% | 48.5% | | | | | broken |
| Example | | | | | | | |
| 14 | | | | | | | |

A: large inorganic particles with a particle size of greater than 1.18 mm
B: Inorganic particles with a particle size of 1.18 mm or less and quartz powder

According to an exemplary embodiment of the present invention, in order to increase the transmittance of artificial marble with transparent large particles connected, the amount of quartz powder with small particles may be reduced, and the contents of liquid resin and solid powder resin may be increased. If only the content of liquid resin is excessively increased, a very wet compound may be formed, which may cause sticking or jamming problems during the process and increase manufacturing costs. Additionally, if the amount of quartz powder added is excessively increased, an opaque region may occur between inorganic particles with a large particle size, which lowers the transmittance. In addition, even when the amount of quartz powder added is too small, voids may occur between particles, which causes pinholes.

As shown in the above results, according to an exemplary embodiment of the present invention, the liquid resin including an unsaturated polyester resin and the solid powder resin are applied at the same time, leading to improvement in dispersibility of the artificial marble composition even when a small amount of quartz powder is applied, and improvement in adhesion between large inorganic particles with a particle size of greater than 1.18 mm. Accordingly, an artificial marble including a large chip-shaped pattern found in natural stones can be manufactured.

1. An E-stone based artificial marble formed of an inorganic particle, inorganic powder, and a resin,
wherein the resin is an E-stone based composition comprising a liquid resin and a solid powder resin or a cured product thereof.

2. The E-stone based artificial marble of claim 1, wherein a content of the liquid resin is 7 wt % to 12 wt %, and a content of the solid powder resin is 8 wt % to 14 wt %, based on a total weight of the E-stone based composition, and
wherein an Avalanche Energy value of the E-stone based composition is 18 mJ/Kg or less.

3. The E-stone based artificial marble of claim 1, wherein the solid powder resin is a thermosetting solid powder resin having a glass transition temperature (Tg) of 50° C. or higher and a melting temperature of 60° C. or higher.

4. The E-stone based artificial marble of claim 1, wherein a temperature at which curing of the solid powder resin begins is 118° C. to 135° C.

5. The E-stone based artificial marble of claim 1, wherein the liquid resin is an unsaturated polyester resin, and
wherein the solid powder resin comprises one or more selected from an epoxy acrylate resin, a glycidyl methacrylate resin, a butyl methacrylate resin, a methyl methacrylate resin, a saturated polyester resin, a copolymer resin formed by polymerizing a methyl methacrylate resin and glycidyl methacrylate, a copolymer resin formed by polymerizing a methyl methacrylate resin and an epoxy acrylate resin, a polyester epoxy hybrid resin, and a resin in which polyester and glycidyl isocyanurate are mixed.

6. The E-stone based artificial marble of claim 1, wherein the E-stone based artificial marble comprises a base region and a pattern region,
wherein a width of the pattern is less than 2 cm and a length is 5 cm or longer, and
wherein a resin composition for a base and a resin composition for a pattern forming the base region and the pattern region, respectively, are different from each other in components, and the pattern region comprises the E-stone based composition or a cured product thereof.

7. The E-stone based artificial marble of claim 6, wherein a deviation of the width of the pattern defined by Mathematical Formula 1 below is 5% or less:
Deviation of width of pattern (%)=[(A−B)/C]×100(%) [Mathematica Formula 1]
in Mathematical Formula 1,
A represents a maximum width of the pattern,
B represents a minimum width of the pattern, and
C represents an average width of the pattern.

8. The E-stone based artificial marble of claim 1, wherein the E-stone based artificial marble has a flexural strength of 2,000 kgf/cm² or higher as measured according to ASTM C170,
wherein the inorganic particle comprises a large inorganic particle with a particle size of greater than 1.18 mm and an inorganic particle with a particle size of 1.18 mm or less, and
wherein the E-stone based artificial marble comprises a region in which, when a sample of at least 5 g of the E-stone based artificial marble is collected and subjected to organic substance removal, washing and drying according to ASTM D2584 (Ash test) and then a remaining inorganic substance is sufficiently sieved out through a 1.18 mm sieve (ASTM E-11, No. 16), a volume ratio of A in Mathematical Formula 2 below is 50% or more or Mathematical Formula 3 below is satisfied where A is a material remaining on the top after the sieving and B is a material having passed through the sieve:
Volume ratio of A=V_{A}/(V_{A}+V_{B})×100=1/[1+(ρ_{A}/ρ_{B})*(m_{B}/m_{A})]×100 [Mathematica Formula 2]
ρ_{A}/ρ_{B}<m_{A}/m_{B} [Mathematica Formula 3]
in Mathematical Formulas 2 and 3,
V_{A} is a volume of A and V_{B} is a volume of B,
ρ_{A} is a specific gravity of A and ρ_{B} is a specific gravity of B, and
m_{A} is a weight of A and m_{B} is a weight of B.

9. A method for manufacturing an E-stone based artificial marble, the method comprising:
forming a base layer into a plate shape by distributing a resin composition for a base into a horizontally oriented mold;
forming an engraved pattern in the base layer;
discharging a resin composition for a pattern into the engraved pattern; and
performing a vibration and compression process and then performing a thermal curing process to form an artificial marble including a base region and a pattern region,
wherein a width of the pattern is less than 2 cm and a length is 5 cm or longer, and
wherein the resin composition for a base and the resin composition for a pattern are different from each other in components.

10. The method of claim 9, wherein the resin composition for a pattern comprises a liquid resin comprising an unsaturated polyester resin, a solid powder resin, an inorganic particle, and inorganic powder.

11. The method of claim 9, wherein an Avalanche Energy value of the resin composition for a pattern is 18 mJ/Kg or less.

12. The method of claim 9, wherein the thermal curing process is performed at temperature of 118° C. or higher for 10 minutes or longer.

13. The method of claim 10, wherein the solid powder resin of the resin composition for a pattern is melted and converted into a liquid resin through the thermal curing process, and then cured.

14. A method for manufacturing an E-stone based artificial marble, the method comprising:
manufacturing an artificial marble composition comprising a liquid resin, an inorganic particle with a particle size of greater than 1.18 mm, an inorganic particle with a particle size of 0.1 mm or greater and 1.18 mm or less, inorganic powder with a particle size of less than 0.1 mm, and a solid powder resin; and
putting the artificial marble composition into a mold, performing a vibration and compression process, and then performing a thermal curing process to form an artificial marble.
